(19) United States
(12) Patent Application Publication
(10) Pub. No.: US 2026/0248117 A1
(43) Pub. Date: Aug. 27, 2026

(54) REEL HANDLE SYSTEM

(71) Applicant: Paul Herbert Kelley, JR., Marshfield, MA (US)

(72) Inventor: Paul Herbert Kelley, JR., Marshfield, MA (US)

(21) Appl. No.: 19/545,112

(22) Filed: Feb. 20, 2026

Related U.S. Application Data
(60) Provisional application No. 63/761,164, filed on Feb. 21, 2025.

(51) Int. Cl. A01K 89/00; A01K 97/00

(52) U.S. Cl. CPC A01K 89/006; A01K 97/00

(57) ABSTRACT

A novel reel handle for deep-sea fishing reel and rod employs a grip with a cord, preferably a conventional soft shackle, that connects the grip and reel loops at least one time, to be secured. The tubular grip may include a battery to power a processor, memory, clock, UV radiation, torque, accelerometer, and other sensors. It has sensors to monitor torsion on the reel, trigger a sensor, track the line tension, location, and time landing the fish and provide maps of the location vs. any measured physical property during a fishing trip.

### CROSS REFERENCE TO RELATED APPLICATION

This application claims the benefit of US Patent Application No. 63/761,164 “Novel Reel Handle”, by Paul Herbert Kelley, Jr. filed 02/21/2025 which is incorporated by reference in its entirety to the extent that it does not conflict with disclosure of this application.

### STATEMENT REGARDING FEDERALLY SPONSORED RESEARCH

Not Applicable.

### BACKGROUND

### 1.Field of Invention

The present invention relates to a device that facilitates manipulating and carrying large commercial deep sea fishing reels and rods. More specifically, the present invention relates to a device that facilitates manipulating and carrying large commercial deep sea fishing reels and rods that includes tools that are helpful to the fishermen.

### 2.Description of Related Art

### Tough moving or manipulating Pro Reels

Commercial deep-sea fishing for large tuna and bluefish requires significantly larger and more expensive equipment than that of a casual lake or pond fishing. Some of these deep-sea fishermen make a living from catching large fish and selling them to commercial fish markets.

There are also recreational deep sea fishing cruises in which a number of people (fishermen) are provided rods, reels, bait and other fishing equipment and supplies for a fishing trip.

For example, please see FIG. 1. It is a simplified system diagram of two prior art deep sea fishing rods 7 and reels 3 each held within a rod holder11 built into the side 13 of a fishing boat

Typically, they would be large rods 7 and reels 3 with line extending to a leader and sinker weights and hooks. The rod 7 typically has a tubular handle 9 which the fisherman can tightly hold with both hands, if necessary.

Since there are long periods in which there are no ‘hits’, or ‘bites’, it is common to secure the rod handle 9 in a rod holder 11. It typically is secured to the boat and has an angled cylindrical passage sized and shaped to receive the rod handle 9.

Once a fish bites on the bait and gets hooked, (a ‘hit’) the fish pulls wildly trying to get off the hook. As long as the fish is hooked and before it either works its way off the hook, or is reeled in, is the fight period landing the fish. During this fight period, the fish may try to swim away from the boat creating significant force pulling on the fishing line. The reels 3 have metal loops 5 on the top. A chain with clips is connected between each of these loops 5 to a fisherman’s chair to prevent the rod 7 and reel 3 from being pulled out of the fisherman’s hands and into the water.

These are big, heavy reels 3, such as those shown in the cable TV shows, such as “Wicked Tuna”. The reels 3 and rods 7 are expensive. Bending, breaking, or scratching the reels 3 and rods 7 can become expensive to fix or replace.

### Linkages scratch expensive reels

In the past they used metal linkages to connect to the reel loops 5. Use of metal linkages typically end up scratching the expensive reels. Scratches reduce the aesthetic look of the reels and devalue them. This becomes more important for commercial fishing boats for tourists.

### Difficult to Manipulate Prior art Rod & Reel

The fish may swim toward the boat, or swim around the boat in which there is little pulling force on the line. When this happens, the fisherman may take the rod 7 and reel 3 out of rod holder 11 and move it to another rod holder at a location that has a more direct angle to the fish.

### Need something to stop rotation

The reel 3, and guiding eyelets are attached above the rod 7. The line passes through the eyelets. The reel 3, eyelets and line are offset from a centerline of the rod handle 9. When fighting the fish, the force can cause rod 7, reel 3, eyelets to spin around the rod’s axis.

There are few places to hold the reel 3 and rod 7 without interfering with its moving parts. Therefore, it is difficult to pull the rod 7 vertically out of the rod holder 9, manipulate the rod 7 and reel 3 while fighting the fish, and insert the rod handle 9 into another rod holder 11 that has a more direct angle toward the fish. Since these reels are 8-10” wide, the commercial rods/reels are heavy and experience a significant pulling force while fighting the fish, it is very difficult to manipulate the rod and reels without significant grab locations.

Currently, there is a also a need for a strong structure attached to large reels to have a structure perpendicular to the length of the rod to facilitate holding and manipulation of the rod and reel.

### Exposed to direct sunlight/UV radiation

Usually, there is no shade from direct sunlight on the boats. The rods and reels (and fishermen) are subjected to direct light for long periods of time. This typically causes some materials to become weakened and develop cracks.

There is currently a need to add structures for manipulation of rods/ reels, made from UV resistant materials.

### Exposed to water/saltwater

The equipment is constantly subject to saltwater exposure. If a structure is created to facilitate manipulation of the rod and reel, it must be resistant to saltwater corrosion.

### First with more lactic acid less valuable

When the fish is hooked and begins fighting to get free, it burns up energy. Fighting causes the fish to develop lactic acid. The longer, and more vigorously the fish fights, the more lactic acid is developed in the fish.

The lactic acid changes the taste of the fish. Lower lactic acid levels result in better tasting fish, that are more valuable than other fish and sell at a higher price.

Currently, there is a need for quantifying the amount of lactic acid created while fighting and landing the fish.

### BRIEF SUMMARY OF THE INVENTION

This invention is a new and novel … for the … industry.

### BRIEF DESCRIPTION OF THE DRAWINGS

The invention's advantages described in this application will become more apparent when read with the exemplary embodiment described in the specification and shown in the drawings. Further, the accompanying drawings and descriptions that follow, like parts are indicated throughout the drawings and description with the same reference numerals, respectively. The figures may not be drawn to scale, and the proportions of certain parts have been exaggerated for the convenience of illustration.

FIG. 1 is a simplified system diagram of two prior art deep sea fishing rods and reels each held within a rod support built into the side of a fishing boat.

FIG. 2 is a simplified diagram of a novel reel handle system according to one embodiment of the current invention, being attached to a deep-sea fishing reel.

FIG. 3 shows one embodiment of the current invention with the cord fed though the tubular grip and one reel loop that has a knot and loop that will connect to each other after being fed through the second reel loop.

FIG, 4 shows one embodiment of the current invention attached to the reel loops of a commercial reel that is mounted on a post.

FIG. 5 is a diagram of a reel handle according to another embodiment of the current invention showing a powered internal compartment with electronic components.

### DETAILED DESCRIPTION OF THE INVENTION

The present invention will now be described in detail by describing various illustrative, non-limiting embodiments with reference to the accompanying drawings. The invention may, however, be embodied in many different forms and should not be construed as being limited to the illustrative embodiments set forth herein. Rather, the embodiments are provided so that this disclosure will be thorough and will fully convey the concept of the invention to those skilled in the art. The claims should be consulted to ascertain the true scope of the invention.

The terminology used herein is to describe particular embodiments only and is not intended to be limiting of the invention. As used herein, the term "and/or" includes any and all combinations of one or more of the associated listed items. As used herein, singular forms "a," "an," and "the" are intended to include the plural forms as well as the singular forms unless the context clearly indicates otherwise. It will be further understood that the terms "comprises" and/or "comprising," when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits, and each can also be used in conjunction with one or more, or in some cases all, of the other disclosed techniques. Accordingly, for clarity, this description will refrain from repeating every possible combination of the individual steps in an unnecessary fashion. Nevertheless, the specification and claims should be read with the understanding that such combinations are entirely within the scope of the invention and the claims.

### 1.Theory

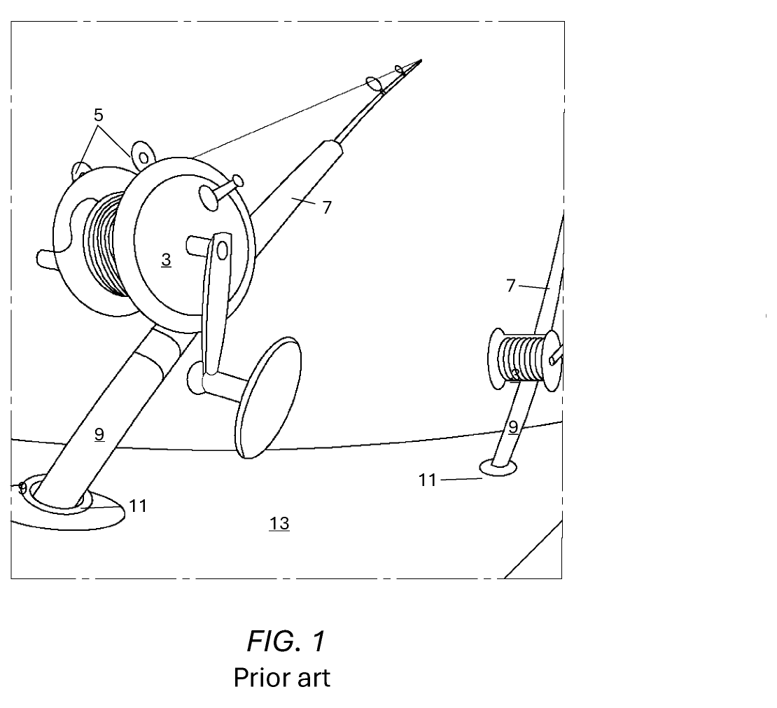

As indicated above, there are currently problems that can be addressed in the deep-sea fishing industry. As shown in FIG. 1, the rod handle 9 is held in a tubular-shaped rod holder 11. The rod holder 11 is fixed to the boat. Conventional reels 3 have metal loops 5 on top for wires that connect to the fisherman’s seat so it does not get pulled into water when there is a strike on it.

### Move Rod/Reel

When the fisherman has a fish on the hook, it swims to try to break free. This may take it to the far left or right. The fisherman may unclip the chains to the chair, take the rod handle 9 out of the rod holder 11 and physically carry the rod 7 and reel 3 to another location on the boat. The fisherman must take rod 7 out of holder 11, unclip it from the seat, and carry it around the boat to another holder 11 on the other side as fish goes under boat.

Some of these fish can be very large and strong. Due to its tubular shape, the rod handle 9 can be yanked out of the fisherman’s hands when moving the rod 7 and reel 3 while fighting the fish.

There is a need for a large, easy to grab, near the center of gravity, that is perpendicular to the direction of force (the fishing line).

In the past, metal clips and chains connected between the reel and chair can tangle. When the tangled chains are pulled, then potentially bend the reel loops 5 on the reel 3. This can damage these expensive reels.

Even if plated with non-corrosive materials, the wet and salty environment eventually corrodes through the plating.

Also, other materials, such as plastics do not hold up well when exposed to direct sunlight and UV rays for many hours during fishing trips. Many times, these rods 7 and reels 3 are placed in holders in the direct sunlight and stay there for many hours.

Different leader lines, weights, lures, bait are used to fish at different depths. If several similar rods and reels are being used with specific, but different, lengths, weights, and baits, after the rods have been moved several times, the fishermen cannot tell what the weights, lengths and baits are for a specific rod and reel. It would be very helpful to identify this information on each rod and reel.

It would be helpful to have a readout of the current weights, leader line length, lure, and/or bait of each rod without having to reel them in to identify these aspects.

Even though there may be several cell phone charging outlets on a boat, there may be many people on a recreational deep sea fishing boat. Since almost everyone has a cell phone and needs to periodically charge it.

There is an ongoing need for additional power outlets and/or charging cell phone outlets for those on board.

The value of large fish is sometimes based upon how much of the meat is ‘burned’ when it is caught. The more intense, and the longer the ‘fight’ when landing a fish, the more lactic acid the fish creates in its muscles (meat). This lactic acid makes the meat less tasty and less valuable. Therefore, it would be an advantage to have an accurate and non-subjective means for measuring the amount of fight and the duration of the fight when landing a large fish.

### 2.Implementation

The current invention may be implemented in several different ways based on the end user's individual requirements.

A new and novel fishing reel accessory is discussed herein.

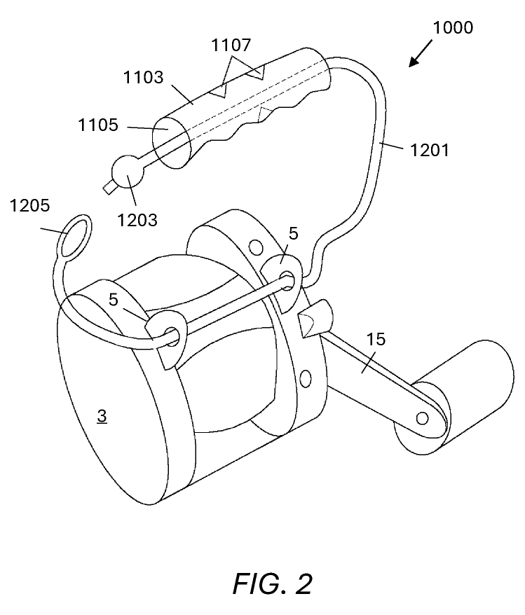

FIG. 2 is a simplified diagram of a novel reel handle system 1000 according to one embodiment of the current invention, being attached to a deep-sea fishing reel 5. A tubular grip 1103 is designed to be made of a material which has high resistance to direct sunlight and ultraviolet rays without deteriorating. Tubular grip 1103 is shaped and sized to be easily held by a fisherman. Tubular grip 1103 may have a slight curve, and ridges for fingers. This shape is an ergonomic design.

Tubular grip 1103 may also be made of a semi rigid material, with a stiffness to resist excessive bending, but allowing for limited flexing.

The tubular grip material can be high-strength polymer that does not corrode with salt, water, does not develop mold, maintains strength, and has advanced UV protection.

It may be made from a common plastic, such as polypropylene, with additives to result in proper stiffness, UV resistance, saltwater corrosion resistance, and other properties.

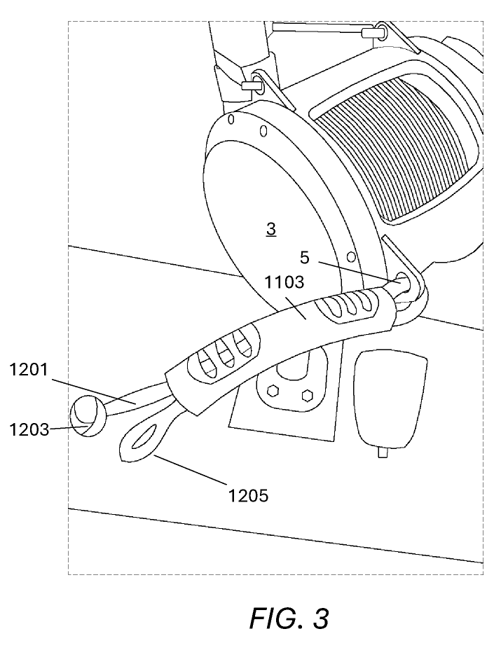

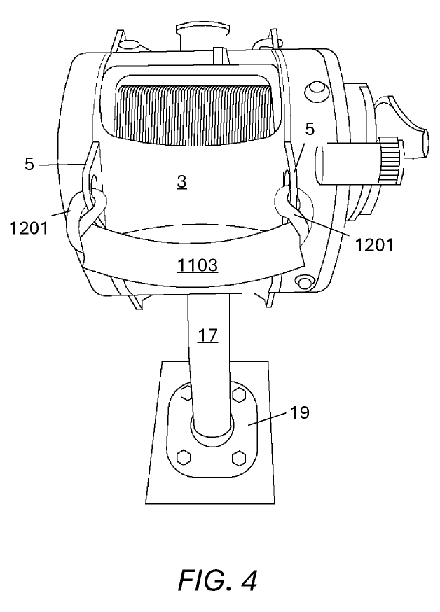

The tubular grip 1103 has an internal passageway 1105 that allows a cord 1201 to pass through it. Cord 1201 is preferably a “Soft Shackle” cord, that is described later in this application. Cord 1201 passes through reel loops 5 of the reel 3. Cord 1201 may loop more than once through internal passageway 1105 and reel loops 5, as shown in FIG. 3. There is a knot 1203 at one end of cord 1201 and a loop 1205 at the other end. The knot 1205 is pushed through the loop 1205 to connect these ends. They are then pushed into the internal passageway 1105 of tubular grip 1107 until it jams in the internal passageway 1105. One way to make the knot 1203 jam in the internal passageway is to partially obstruct the internal passageway 1105 by creating a narrowed portion in the internal passageway which sill allow the cord 1201 to pass through but is too narrow to allow the knot 1203 to pass through.

Optionally there can be protrusions 1107 which narrow the passageway, securing the knot 1203, loop 1205 and cord 1201. The result is a tubular grip 107 that can be quickly attached or detached by simply pulling the knot 1203 out of the internal passageway 1105 in a direction opposite that of insertion.

As indicated above, the cord 1201 is preferably a ‘Soft Shackle” cord. The Soft Shackle cord is a weaved rope of polypropylene, or other polymer that has high strength, does not develop mold, does not corrode in wet environments, or strong UV rays.

Using a Soft Shackle results in a handle as a soft cord 1201 that does not corrode or develop mold in saltwater conditions, does not scratch the reels 5, is resistant to UV radiation, and is exceedingly strong.

The design is such that the reel handle 1000 is perpendicular to a pulling force on the fishing line, maximizing leverage on the rod 7. The design of the reel handle 1000 allows for leverage when fighting large fish, while not compressing the user’s hands, or bending the attachment loops of the reels. The semi-rigid plastic tubular grip has a curved tubular shape.

FIG. 3 shows another embodiment of the current invention partially attached to the reel 3. The cord 1201 has been fed though the tubular grip 1103 and one reel loop 5. The cord 1201 has knot 1203 and loop 1205. Knot 1203 is intended to pass through, and connect to the loop 1205 after the cord 1201 is fed through the second reel loop (5 of FIGS. 1 and 2). The knot 1203 and loop 1205 are jammed into the tubular grip 1203 and friction held by protrusions (1107 of FIG. 2).

FIG, 4 shows one embodiment of the current invention fully attached to the reel loops 5 of a commercial reel 3 that is mounted on a post 17 that is connected to a flange 19 that is secured to a stationery structure on the ship.

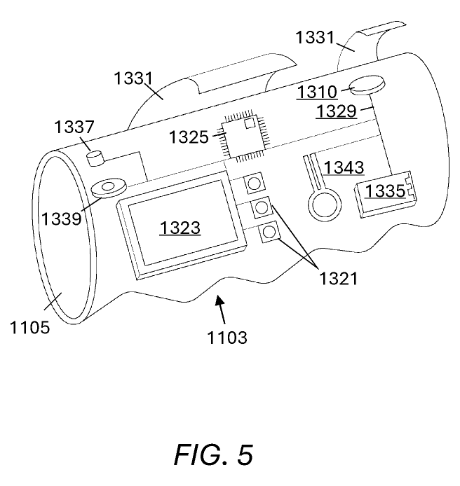

FIG. 5 is a diagram of a portion of the reel handle 1000 according to another embodiment of the current invention showing a powered internal compartment 1300 with electronic elements.

In one embodiment of the reel handle system 1000, it includes a rechargeable battery 1310 that powers a small processor 1325 through power leads 1329 to a power connection 1320.

In another embodiment, the power connection 1320 may be a USB port capable of charging or powering small electronic devices, such as a cell phone.

Processor 1325 is connected to a memory 1327 which contains executable code run by processor 1325. Memory 1327 also has data regions, scratch areas and data storage areas.

In this embodiment, processor 1325 and memory 1327 are in an electrical compartment 1300 that has a door 1333 that closes the compartment 1300. In this embodiment, there is a hinged battery door 1331 that closes and covers the battery 1310.

There are input devices, such as buttons 1321 to provide input to the processor 1325. There are also output devices, such as a display 1323. When processor 1325 is running executable code from memory 1327, it can display options on display 1323 and receive input from buttons 1321 to perform numerous tasks that are helpful to a fisherman.

For example, the processor 1325 may run executable code from the memory 1327 to allow the fisherman to enter setup information for the rod. This user may enter the weights used, the leader length, the bait, and other setup information for this rod. The executable code then allows the user to later view this setup information on display 1323 to quickly identify the setup of this rod.

Another embodiment can use executable code prestored within memory 1327 may cause processor 1325 to request information, through a communication device 1335 (which may be a Bluetooth device 1335, or other conventional wireless communication device), from other equipment, labeled as “site 15”. (Possibly, site 15 may have communication equipment, such as satellite technology, that connects to websites on the Internet.) Processor 1325 then downloads the information from site 15 into memory 1327. The information downloaded may then be accessed by the user. One example of this information is tidal tables. It is useful for the user (fisherman) to know when high and low tides are occurring at his/her location. The fisherman may adjust fishing depths base upon this information.

Other useful information may be downloaded, such as the local fishing regulations, indicating the minimum size of each type of fish that can be kept, what the fishing limits are. It is also helpful to download what types of fish are running near the current location, regions that are close to being overfished, depth maps, etc.

In still another embodiment, tubular grip 1103 can incorporate a sensor pack 1337 that can monitor physical conditions, such as UV exposure, temperature, precipitation, barometric pressure, etc. It is attached to processor 1325 that runs executable code stored in memory 1327 that can monitor, accumulate, correlate, and perform various calculations on one or more sensed physical conditions. It may also provide notices, warnings, or alarms that can be displayed on display 1323. These notices, warnings or alarms can be audible sounds, or speech played through a speaker 1339.

Some of these may be warnings of overexposure to UV radiation, the current temperature, the maximum and minimum temperatures during a fishing session.

The sensor pack 1337 can have an accelerometer which measures quick movement of the fishing line. It can have an extension which also monitors quick movements of the line. This would indicate a ‘bite’ or ‘strike’ on the line. This could create an alarm to get the attention of the fisherman.

Also, a conventional torque meter (not shown) can be mounted within the reel 3 to measure turning force. This will be directly related to the pull on the fishing line. If the processor 1325 is coupled to this torque meter, and to the clock 1341, it can keep track of the fighting force of the fish during the landing period. This can later be normalized to consider the weight of the fish landed, to provide an estimate of lactic acid developed. This is important in setting a price for the fish.

An executable program in memory 1327 run by processor 1325 can determine when the fisherman is ‘fighting’ with a fish. This can be accumulated for the entire period required to land the fish. This can be converted into an estimate of the amount of lactic acid buildup that affects the quality and cost of the fish. This reading can be provided to a potential buyer.

In still another embodiment, a global positioning system (GPS) 1339 with a clock 1341 is attached to the tubular grip 1203 and the processor 1325. It determines the location of the tubular grip 1203. The processor 1325 runs executable code stored in memory 1327 that allows it to not only determine current location but to keep track of the location over a period of time. If initialized at the beginning of a fishing trip, it can be correlated providing maps of time, location crossed with any measured physical property. Therefore, there can be a map of location over time indicating temperature, UV radiation, where bites took place, where the boat drifted during the fight landing a fish, etc.

Also, since these commercial reels 3 are costly, the GPS tracking can allow locating the the reel 3 and recovering it in the event that one is dropped into shallow waters.

Also, a tracking device may be attached to or inserted into the leader or lure (not shown here). If it has the capability of tracking its location under water and communicating this back to the communications device 1335.

Other conventional electronic devices 1343 that monitor or track the location of the reel 3 or leaders may be implemented.

While the present disclosure illustrates various aspects of the present teachings, and while these aspects have been described in some detail, it is not the intention of the applicant to restrict or in any way limit the scope of the claimed systems and methods to such detail. Additional advantages and modifications will readily appear to those skilled in the art. Therefore, the teachings of the present application, in its broader aspects, are not limited to the specific details and illustrative examples shown and described. Accordingly, departures may be made from such details without departing from the spirit or scope of the teachings of the present application. Moreover, the preceding aspects are illustrative, and no single feature or element essential to all possible combinations may be claimed in this or a later application.

We claim:

1. A novel reel handle system for manipulating and carrying a commercial fishing reel having reel loops connected to a fishing rod comprising:
a. a curved tubular grip approximately the width of the commercial fishing reel having in internal passageway;b. a high tensile strength cord that exhibits superior resistance to UV rays, mold, and salt corrosion, passes through the internal passageway of the tubular grip, through the reel loops of the fishing reel and is secured in the tubular grip.

2. The novel reel handle system of claim 1, further comprising:
a. a commercial fishing reel with reel loops;b. a power source for providing electric power,c. a torque sensor in the reel for measuring tension on the fishing line;d. a clock for measuring elapsed time, coupled to the power source;e. a processor connected to the power source, the torque sensor, and the clock which can monitor the torque exerted on the reel over the time it takes to land a fish during this “landing period” and uses the information to estimate the amount of lactic acid built up in the fish.

3. The novel reel handle system of claim 1, further comprising:
a. a power source,b. a sensor pack having an accelerometer that measures quick movements of the fishing line indicating a ‘strike’,c. a global positioning system (GPS) that monitors the location of the reel over time; d. a processor connected to the power source, the sensor pack, and the GPS which can track the location of the reel, such as after an initial strike and through the fighting period.

4. The novel reel handle system 1000 of claim 1, further comprising:
a. a power source 1310,
b. a global positioning system (GPS) on a leader connected by fishing line to the reel;
c. a wireless communication device on the leader allowing the GPS to transmit its location over time;
d. a wireless communication device on the curved tubular grip that can receive transmissions from the GPS;
e. a processor connected to the power source, and the wireless communication device on the curved tubular grip capable of receiving the transmitted location of the GPS, and storing its location over time.

5. The novel reel handle system of claim 1, further comprising:
a. a power source for providing electric power,b. a sensor pack that receives power from the power source for monitoring various physical properties.

6. The novel reel handle system of claim 5 wherein the sensor pack measures accumulated ultraviolet radiation from a specified point in time.

7. The novel reel handle system of claim 6 wherein the sensor pack measures accumulated ultraviolet (UV) radiation from a specified point in time and sets off an alarm when the accumulated UV radiation exceeds a preset threshold.

8. The novel reel handle system of claim 1, further comprising:
a. a power source for providing electric power, andb. a USB or other conventional plug that can power other small electronics devices.

9. The novel reel handle system of claim 1, wherein the cord is a conventional soft shackle material.

10. A novel reel handle system for manipulating and carrying a commercial fishing reel having reel loops connected to a fishing rod comprising:
a. a curved grip approximately the width of the commercial fishing reel;
b. a high tensile strength cord that exhibits superior resistance to UV rays, mold, and salt corrosion, that connects the grip, through the reel loops at each end of the grip to secure it to the reel.

11. The novel reel handle system of claim 10, wherein the cord is a conventional soft shackle material.

12. The novel reel handle system of claim 10, further comprising:
a. a commercial fishing reel with reel loops;
b. a power source for providing electric power,
c. a torque sensor in the reel for measuring tension on the fishing line;
d. a clock for measuring elapsed time, coupled to the power source;
e. a processor connected to the power source, the torque sensor, and the clock which can monitor the torque exerted on the reel over the time it takes to land a fish during this “landing period” and uses the information to estimate the amount of lactic acid built up in the fish.

13. The novel reel handle system of claim 10, further comprising:
a. a power source,
b. a sensor pack having an accelerometer that measures quick movements of the fishing line indicating a ‘strike’,
c. a global positioning system (GPS) that monitors the location of the reel over time;
d. a processor connected to the power source, the sensor pack, and the GPS which can track the location of the reel, such as after an initial strike and through the fighting period.

14. The novel reel handle system of claim 10, further comprising:
a. a power source,
b. a global positioning system (GPS) on a leader connected by fishing line to the reel;
c. a wireless communication device on the leader allowing the GPS to transmit its location over time;
d. a wireless communication device on the curved tubular grip that can receive transmissions from the GPS;
e. a processor connected to the power source, and the wireless communication device on the curved tubular grip capable of receiving the transmitted location of the GPS and storing its location over time.

15. The novel reel handle system of claim 10, further comprising:
a. a power source for providing electric power,
b. a sensor pack that receives power from the power source for monitoring various physical properties.

16. The novel reel handle system of claim 15 wherein the sensor pack measures accumulated ultraviolet radiation from a specified point in time.

17. The novel reel handle system of claim 16 wherein the sensor pack measures accumulated ultraviolet (UV) radiation from a specified point in time and sets off an alarm when the accumulated UV radiation exceeds a preset threshold.

18. The novel reel handle system of claim 10, further comprising:
a. a power source for providing electric power, and
b. a USB or other conventional plug that can power other small electronics devices.

19. The novel reel handle system of claim 1, wherein the cord is a conventional soft shackle material.

20. A method of carrying and locating a commercial fishing reel having reel loops, comprising the steps of:
a. coupling a grip to the reel loops with a high tensile strength cord that exhibits superior resistance to UV rays, mold, and salt corrosion;
b. mount a power source on the grip;
c. mount a GPS device on the grip and connect it to the power source;
d. attach a conventional communications device to the GPS device, capable of transmitting the location of the GPS device,
e. tracking the location of the reel with a device that can receive the transmission of the conventional communications device.
